(19) United States
(12) Patent Application Publication
(10) Pub. No.: US 2015/0077239 A1
(43) Pub. Date: Mar. 19, 2015

(54) Electric Vehicle Charger Display System for Distant and Local Viewing

(71) Applicant: AeroVironment, Inc., Monrovia, CA (US)

(72) Inventor: ROBERT THOMAS LITJEN, Pasadena, CA (US)

(21) Appl. No.: 14/304,484

(22) Filed: Jun. 13, 2014

Related U.S. Application Data
(63) Continuation of application No. PCT/US2012/070189, filed on Dec. 17, 2012.
(60) Provisional application No. 61/576,939, filed on Dec. 16, 2011.

(51) Int. Cl. B60L 11/18; H02J 7/00

(52) U.S. Cl. CPC B60L 11/1824; H02J 7/0047
USPC 340/455; 320/109

(57) ABSTRACT

An electric vehicle (EV) charger system, includes an EV charger, the EV charger having a distance display disposed at a top portion of the EV charger, the EV charger configured to display a non-alphanumeric representation of a plurality of modes of the EV charger on the distance display for viewing by an observer remote from the EV charger, and a near display disposed at a position on the EV charger that is below the distance display, the EV charger configured to display alphanumeric information on the near display for viewing by a user proximal to the EV charger.

### CROSS-REFERENCE TO RELATED APPLICATIONS

This application is a continuation of International Application No. PCT/US2012/070189 filed Dec. 17, 2012, which claims priority to and the benefit of U.S. Provisional Application No. 61/576,939, filed Dec. 16, 2011, all of which are hereby incorporated by reference herein in their entirety for all purposes.

### BACKGROUND

1. Field of the Invention

The field of the invention is electric vehicle (EV) chargers, and more particularly EV chargers that are intended for use in public locations.

2. Description of the Related Art

As electric vehicles become more prevalent, businesses and local governments will serve the needs of the owners of such vehicles by installing permanently placed electric vehicle (EV) chargers in public places. Unfortunately, charging the battery of an EV, whether in a fully electric vehicle or a plug-in hybrid, may take longer than filling the gasoline tank of a more traditional vehicle. It may be difficult for a passer-by to determine the time remaining for an existing user to complete their charge, and an EV owner may or may not wish to wait. A need exists to better communicate the availability of EV chargers to potential users of the EV charger.

### SUMMARY

An electric vehicle (EV) charger system includes, in one embodiment, an EV charger, the EV charger having a distance display disposed at a top portion of the EV charger, the EV charger configured to display a non-alphanumeric representation of a plurality of modes of the EV charger on the distance display for viewing by an observer remote from the EV charger, and a near display disposed at a position on the EV charger that is below the distance display, the EV charger configured to display alphanumeric information on the near display for viewing by a user proximal to the EV charger. The distance display may include a plurality of lights arranged in a circular pattern. The plurality of lights may be disposed under a translucent cover. The EV charger may be configured to drive the plurality of lights to simulate a light orbiting about a center of the distance display while in an EV charger mode that is selected from the group consisting of: an initial start-up mode, a powering up mode, a shutting down mode, a software update mode, a diagnostic check mode, a communicating mode, and a charging instructions mode. The EV charger may be configured to drive the plurality of lights to simulate a plurality of lights orbiting about a center of the distance display. The EV charger may be configured to drive the plurality of lights to simulate one or more stationary lights while in charging mode, the number of stationary lights displayed spanning a percentage of the perimeter of the distance display that is in proportion to the state of charge (SOC) of a charging EV, when an EV is connected to the EV charger for charging. In such an embodiment, the EV charger may be configured to display a scale on the near display indicating the SOC of the charging EV for viewing by the user. The EV charger may also include a charging connector for connecting to an electric vehicle.

In another embodiment, an electric vehicle (EV) charger system may include a charging connector for connecting to an electric vehicle, a near display for displaying information to a user of the charger, wherein the information relates to at least one of the operation of the charger and the status of the vehicle, and a distant display for displaying information related to at least one of the operation of the charger and the status of the vehicle, viewable by a user at a distance from a charger. The distance that the distance display is viewable by a user may be greater than the distance that a user can view information on the near display. The near display may be a flat panel monitor having a touch screen. The distant display may have a circle of lights that may be individually illuminated in patterns, and the circle of lights may be illuminated to show a set of lights orbiting about a center of the distant display when the charger is available for use. The circle of lights may be illuminated to show at least generally the state of charge (SOC) of the vehicle.

In another embodiment, a method of displaying charging status of an electric vehicle (EV) charger system may include displaying a non-alphanumeric representation of at least one of a plurality of modes of an EV charger on a distance display disposed at a top end of the EV charger, and displaying alphanumeric information on a near display disposed at a position on the EV charger that is below the distance display. Displaying the non-alphanumeric representation of the at least one of the plurality of modes of an EV charger may include displaying a plurality of lights in sequence to simulate a light orbiting about a center of the distance display. Displaying the non-alphanumeric representation of the at least one of the plurality of modes of an EV charger may include displaying a plurality of lights in sequence to simulate a plurality of lights orbiting about a center of the distance display. Displaying alphanumeric information on the near display may also include displaying a user welcome screen. In another embodiment, the method may include tapping a key fob on the near display to start the EV charger for a user to charge an electric vehicle. The method may also include displaying on the near display instructions for use of the EV charger in response to said tapping said key fob and switching the simulation of the plurality of lights orbiting about the center of the distance display to a simulation of a single light orbiting about a center of the distance display. Displaying the non-alphanumeric representation of the at least one of the plurality of modes of an EV charger may include displaying a plurality of stationary lights, the plurality of stationary lights spanning a percentage of the perimeter of the distance display that is indicative of the state of charge (SOC) of a charging EV. In such an embodiment, a span of 100% of the perimeter of the distance display attained by the plurality of stationary lights may indicate an 80% charge of the electric vehicle in accordance with Level 3 charging. A span of 100% of the perimeter of the distance display attained by the plurality of stationary lights may also indicate an 100% charge of the electric vehicle in accordance with Level 2 charging. The method may also include displaying on the near display a scale indicating the state of charge (SOC) of the charging EV.

In another embodiment for displaying charging status of an electric vehicle (EV) charger system, the method may include displaying in a distant display of an EV charger a single orbiting light to indicate a charger powering up mode for observers remote from the EV charger, and displaying in a near display of the EV charger a power-up message to indicate the charger powering up mode. The method may also include displaying on the distant display a plurality of orbiting lights to indicate a charger ready-for-use mode for observers remote from the EV charger system, and displaying on the near display a welcome screen to indicate the charger ready-for-use mode for a user. The method may also include displaying on the distant display a plurality of orbiting lights during a user initiated session for observers remote from the EV charger system, and displaying in the near display instructions to connect the charger to the electric vehicle. Some embodiments may include displaying on the distant display a single orbiting light during a user initiated session for observers remote from the EV charger system, and displaying in the near display instructions to connect the charger to the electric vehicle. The method may include displaying on the distant display a single orbiting light during a communicating mode for observers remote from the EV charger system, and displaying in the near display charger communication information for the user. The method may include displaying on the distant display a plurality of lights spanning a portion of a perimeter of the distant display, the ratio of the portion of the perimeter to the complete perimeter indicative of the general state of charge (SOC) of the electric vehicle for observers remote from the EV charger system, and displaying in the near display a specific SOC percent of the electric vehicle for the user. In other embodiments, the method may include displaying on the distant display a plurality of lights spanning the entire perimeter of the distant display to indicate completion of charging of the electric vehicle for observers remote from the EV charger system, and displaying in the near display a SOC percent of the electric vehicle for the user that indicates the charge of the vehicle is complete. The method may also include displaying on the distant display a plurality of orbiting lights after charging of the electric vehicle is complete, and displaying in the near display instructions for detaching a charging connector from the electric vehicle and for returning the charging connector to a cradle of the EV charger.

### BRIEF DESCRIPTION OF THE DRAWINGS

The components in the figures are not necessarily to scale, emphasis instead being placed upon illustrating the principals of the invention. Like reference numerals designate corresponding parts throughout the different views.

FIGS. 1 and 2 are perspective and plan views, respectively, of one embodiment of an EV charger that has distance and near displays;

FIG. 3 is a partial perspective view of the distance display 105 illustrated FIGS. 1 and 2;

FIGS. 4A, 4B, and 4C illustrate one embodiment of information that may be provided by the distance and near displays when the EV charger is available for use;

FIGS. 5A, 5B, and 5C illustrate one embodiment of information provided by the near display 110, preferably after a user initiates a new charging session;

FIGS. 6A and 6B illustrate one embodiment of information provided by the near display 110 after the EV charger detects that the electric vehicle is in communication with the EV charger;

FIGS. 7A, 7B, 7C, 7D, and 7E illustrate one embodiment of information that may be provided by the distance and near displays when an electric vehicle is charging;

FIGS. 8, 9 and 10 illustrate successive screens displayed on the near display after conclusion of charging of an electric vehicle;

FIG. 11 is a block flow diagram illustrating one embodiment of a method for displaying EV charger mode information;

FIG. 12 depicts a user seated at a remote distance from the EV charger awaiting indication on the distance display that the electric vehicle is fully charged; and

FIG. 13 depicts a user that is proximal to the EV charger for viewing the near display.

### DETAILED DESCRIPTION

An electric vehicle (EV) charger system having a display system for distant and local viewing includes both near and distance displays that are uniquely positioned and configured to display information that is relevant and viewable to observers at both locations. Disposed at a top portion of the EV charger is a distance display for remote observers of the EV charger, the distance display configured to display a non-alphanumeric representation of a plurality of modes of the EV charger. For potential users of the EV charger, this non-alphanumeric representation may be a series of orbiting or stationary lights intended to convey whether the EV charger is currently available for use and/or the state of charge (SOC) of any connected electric vehicle. For service personnel observing the EV charger remotely, the series of orbiting or stationary lights may convey whether the EV charger is in one of an initial start-up mode, a powering up mode, a shutting down mode, a software update mode, a diagnostic check mode, a communicating mode, and a charging instructions mode. For observers of the EV charger that are not remote from the EV charger, such as a user standing in front of the EV charger, a near display is provided that is disposed at a position below the distance display and facing the user for easy local viewing. The near display may be configured to display alphanumeric information to convey not only the SOC of the connected electric vehicle, but also instructions for use of the EV charger.

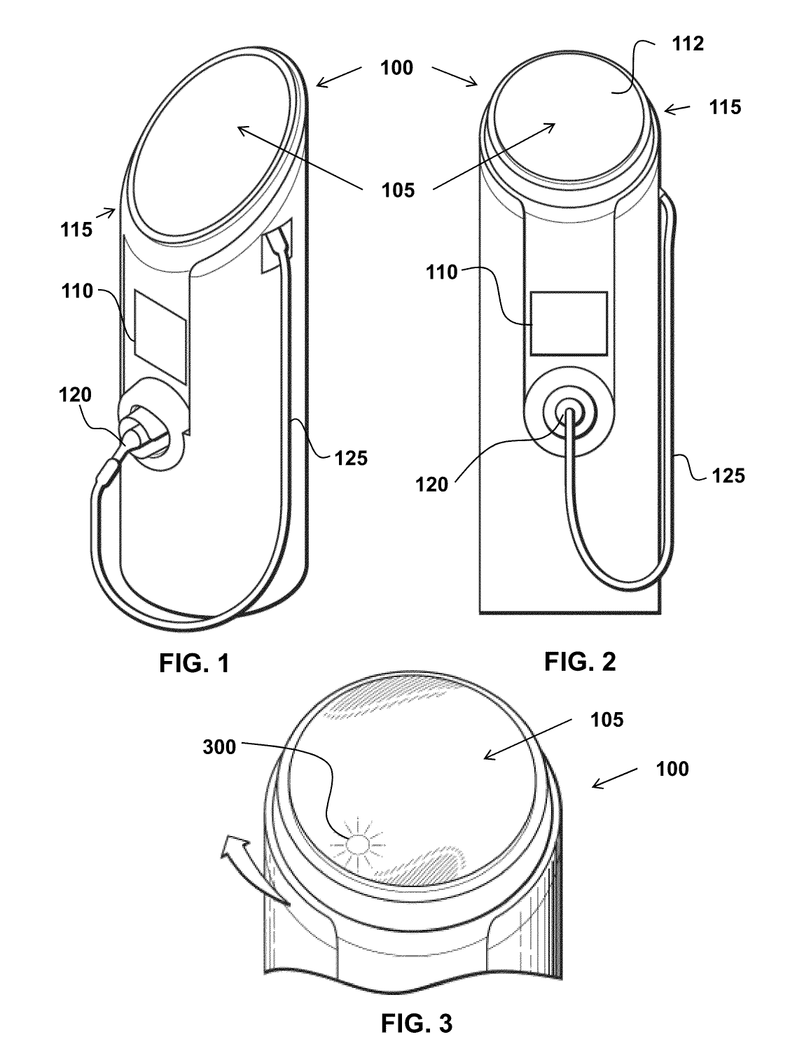

FIGS. 1 and 2 are perspective and plan views, respectively, of one embodiment of an EV charger 100 that has distance and near displays (105, 110) for providing information to actual users, potential users, or service technicians of the EV charger that may positioned at remote or proximal positions from the EV charger. A person that is proximal to the user may be an actual user and so may need information related to the operation of the charger or status of the vehicle such as connecting or disconnecting the charger to the vehicle, starting or stopping the charging, authorizing the charging, payment, specific charging rate, SOC, cost of charging (e.g., dollars and cents) error messages, maps, interactive screens and menus, and the like. The EV charger 100 may be configured to display such detailed information using alphanumeric information on the near display such as words, phrases and other textual information as well as graphical representations of such information. In one embodiment, the near display may incorporate a user interface, such as a touch screen, or may have an interface adjacent thereto, such as a keyboard. In at least one embodiment, the EV charger 100 has a near display 110 that is a touch screen monitor positioned in the front of the EV charger and positioned at a height that makes it easy for the user to view and operate relatively close up.

In contrast, a person such as a potential future user, a service tech, or a location manager for the EV charger 100 may be positioned remotely from the EV charger 100, namely, at a distance sufficiently away from the EV charger as not to be capable of accurately viewing, and/or interacting with, the information on the near display. The distant display 105 may be positioned at or near the highest point on the EV charger, such as at a top portion 115 of the EV charger 100, to facilitate clear viewing of the distance display 105 from a distance (i.e., remote from the EV charger) and at angles about the EV charger 100.

The distance display 105 may include a translucent cover 112 that covers a plurality of lights (not shown) positioned in a circle or about a perimeter of the distance display 105 at the top or upper portion of the EV charger, with the translucent cover 112 such that the plurality of lights are not visible by an observer until illuminated. As used herein, the word “light” may refer to an incandescent light bulb, fluorescent light, compact fluorescent light, LED or other source of illumination. When driven with a current, the one or more lights may be used to simulate the appearance of one or more “lights” that appear stationary or moving on the distance display 105, depending on their control and sequencing by the EV charger 100. Also, the words “orbit” or “rotate,” when referring to light movement herein, may refer to angular rotation of a light about a center area of the distance display 105 whether or not a constant radius of rotation or constant angular rate is provided.

The distance display 105 may be configured to convey information over a large range of distances that a person may be positioned away from the EV charger 100, wherein the distance that the distance display 105 is viewable by an observer is greater than the distance that a user can view information on the near display 110. The person positioned remotely from the EV charger may need more generalized information such as the current status and operation of the charger. For example, given the length of a typical charging session for an electric vehicle (typically about 30 minutes) a user may spend the charging time at an adjacent store, restaurant, coffee shop, etc. and watch the distant display as a remote observer to determine the status of the charging. In another example, the observer may be someone driving past the location of the EV charger that may look at the distance display 110 to determine the EV charger's status prior to further approaching the EV charger 100 (i.e., driving past on a highway and obtaining the status of the EV charger 100 prior to exiting the freeway).

The distance display 105 may be larger than the near display 110 to enable conveyance of information to distant locations, such as by an observer remote from the EV charger. In the illustrated embodiment of FIGS. 1 and 2, the distance display 105 is an elliptical display that is angled towards a front of the EV charger 100, rather than merely displaying vertically. In other embodiments, the distance display 105 is round, rectangular or defines another shape, may form a curved surface, and may be angled to display horizontally towards a remote viewer, rather than being merely tilted towards the remote viewer.

The near and distant displays (110, 105) may change their display content to reflect the mode that the EV charger 100 is operating in at the time. The near display 110 may also be known as the detailed information display and the distant display 110 may be known as the far or the general information display. The EV charger 100 has a charging connector 120 for connecting to an electric vehicle through a charging cable 125.

FIG. 3 is a partial perspective view of the distance display 105 illustrated in FIGS. 1 and 2, with the distance display 105 indicating a non-user mode. The EV charger 100 may be configured to simulate the appearance of a light 300 circling or orbiting about a center of the distance display 105 during predetermined EV charger modes. For example, when the EV charger is in a non-user mode, such as initial start-up, powering up, shutting down, performing software updates, experiencing errors, performing diagnostic checks, etc., the distance display 105 may show a circling, or orbiting, light 300 for viewing by a remote observer. The light 300 may have a steady illumination, may appear to pulsate or may have a predetermined color, radius, intensity, or speed to convey a particular non-user mode. For example, a red orbiting light may indicate the EV charger 100 is experiencing errors or is otherwise unavailable for charging use. A green orbiting light may indicate initial start-up or powering up modes. A yellow pulsating orbiting light may indicate the EV charger 100 is performing diagnostic checks. Because the non-alphanumeric orbiting light 300 does not require any particular resolving power of the human eye, the conveyed information may be seen and understood by a remote observer at greater distances than would be possible using alphanumeric information, such as that described above for the near display.

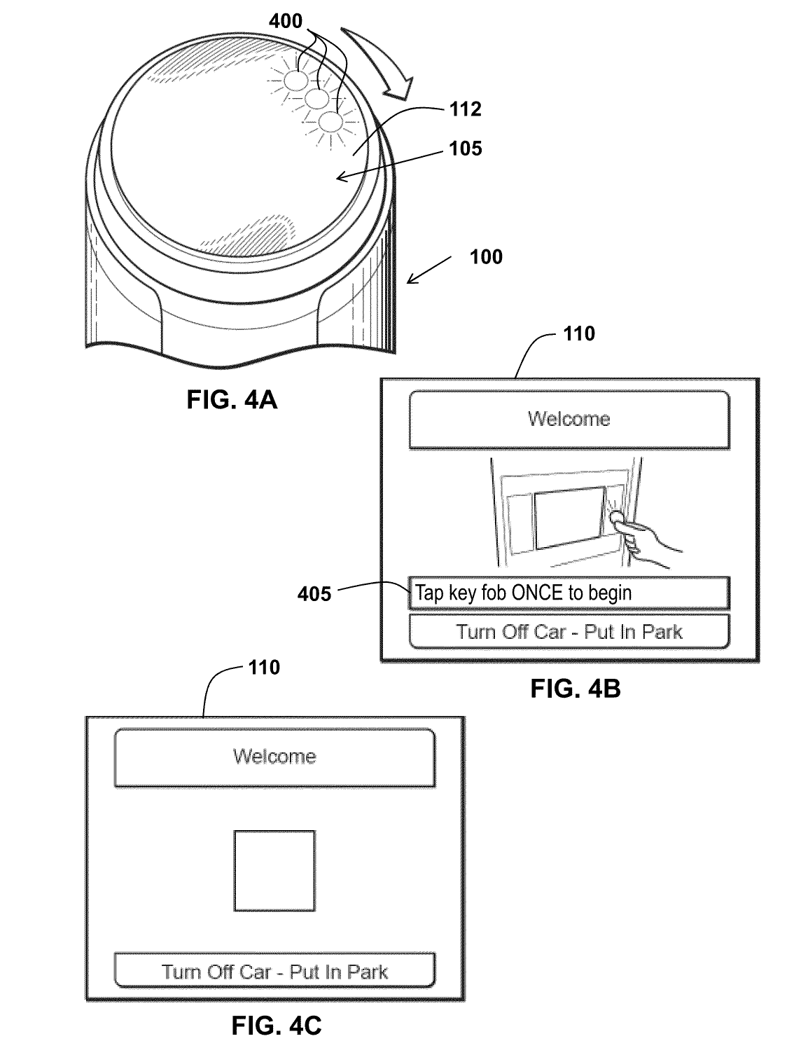

FIGS. 4A, 4B, and 4C illustrate information provided by the distance and near displays when the EV charger is available for use. In FIG. 4A, non-alphanumeric information may be displayed in the form of a plurality of lights 400 orbiting about a center of the distance display 105. This gives a remote observer that is a potential customer the ability to determine from a distance whether the EV charger is available for use. The white arrow in FIG. 4A may indicate the direction of rotation of the plurality of lights in this embodiment. In another embodiment, the direction of rotation is in the opposite direction. Although three lights 400 are illustrated, the three lights may be formed by any number of actual lights under the translucent cover 112 that are illuminated and sequenced by the EV charger 100. In alternative embodiments, fewer or more lights are simulated as orbiting about the center of the distance display 105. In a preferred embodiment, each of the plurality of lights 400 orbit at a steady angular velocity, angular direction, intensity, and color about a center of the distance display 105. In alternative embodiments, one or more of the angular velocity, angular direction, intensity, and color may be varied to both convey the availability of the EV charger and to capture the attention of potential remote users.

In a preferred embodiment, while the plurality of lights 400 orbit about a center of the distance display 105, the near display 110 displays alphanumeric information for viewing by potential users proximal to the EV charger. The near display 110 may alternate between displaying instructions for beginning a charging session (FIG. 4B) and providing a simple welcoming screen (FIG. 4C). In one example, the near display 110 illustrates starting a charging session passing a key fob once on the near display 405. In an alternative embodiment, the near display 110 may display a message instructing a user to select a payment option, insert a credit or debit card or to select “start a new charging session.” In other embodiments, the charging session is preceded by charging instructions. In an alternative embodiment, the distance display 105 displays alphanumeric information that is nevertheless resolvable by the human eye at a remote distance from the EV charger 100. For example, the distance display may display a single character or symbol, or a limited number of characters or symbols, that inherently provide information that is beyond the simple display of the character or symbol itself. In one embodiment, one or more numbers may be displayed to represent the percent SOC of a connected electric vehicle that is charging. In another embodiment, the symbol is a simple green “check” mark indicating the availability of the EV charger for new customers or a large red “X” mark indicating the EV charger is unavailable for use.

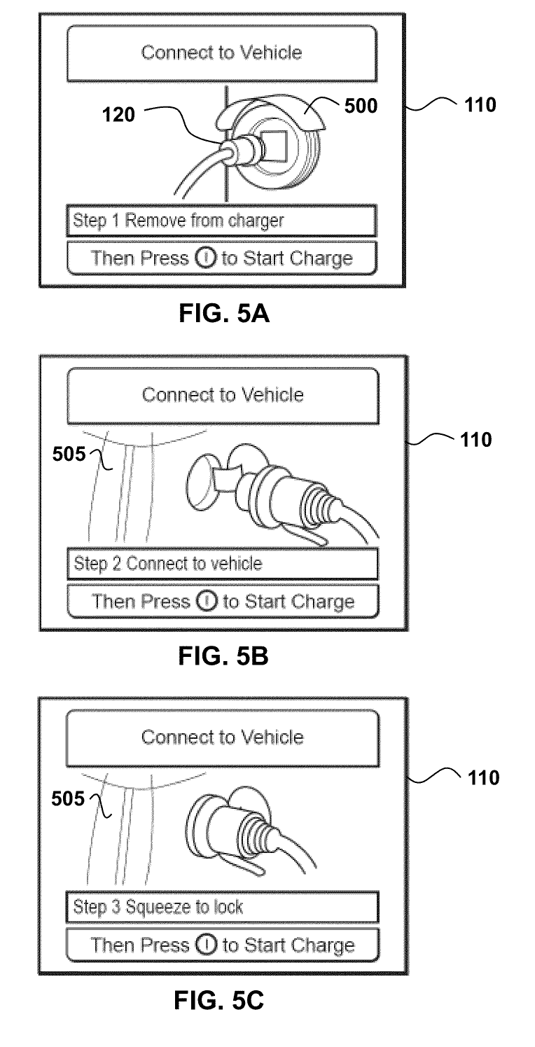

FIGS. 5A, 5B, and 5C illustrate information provided by the near display 110, preferably after a user initiates a new charging session with the EV charger according to instructions previously provided, such as that illustrated in FIG. 4B. For example, after the user taps their key fob on the near display 110 or on a key fob sensor adjacent the near display, the first of three screens (see FIG. 5A) may be displayed to instruct the user how to operate the EV charger to charge an electric vehicle, such as how to remove the charging connector 120 from the EV charger holster 500, to connect the charging connector 120 to the user's electric vehicle (see FIG. 5B) and how to “lock” the charging connector 120 to the electric vehicle 505. In an alternative embodiment, the series of three screens displayed on the near display 110 to provide operating instructions may be replaced by a video segment or any number of screen shots that collectively convey how to operate the EV charger system. Upon initiation of the operating instructions, the distance display may be switched to display a circling (rotating or orbiting) plurality of lights about the distance display, such as the plurality of lights 400 first illustrated in FIG. 4A. In an alternative embodiment, the distance display displays a single orbiting light as first illustrated in FIG. 3 so that an observer remote from the EV charger may see that the charger is not available for their use at that time, as well as that the current user is just starting a charging session, so the wait may be up to 30 minutes or so depending on the current state-of-the-art EV chargers and electric vehicles.

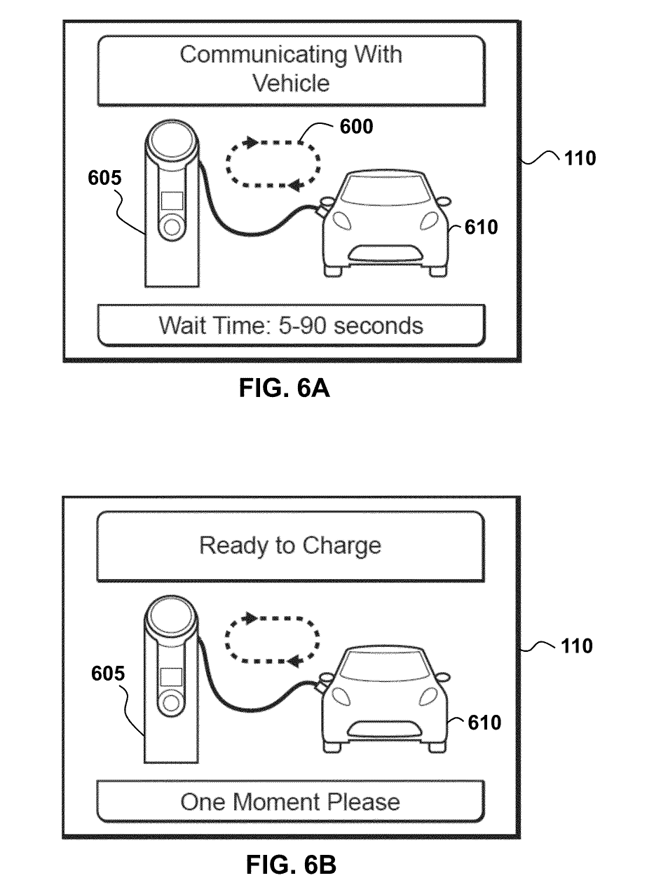

FIGS. 6A and 6B illustrate information provided by the near display 110, preferably after the EV charger detects that the electric vehicle is in communication with the EV charger through the charging cable (see FIGS. 1 and 2). The near screen 110 may switch to a communication screen as the EV charger and electric vehicle begin to communicate (FIG. 6A). The communication may be represented by rotating yellow arrows 600, while the EV charger and electric vehicle are represented in the near display 110 by an EV charger icon 605 and electric vehicle icon 610, respectively. The yellow arrows 600 may rotate to suggest or indicate that data is transferring back and forth between the EV charger and electric vehicle. The EV charger may be configured during this communication mode to drive the plurality of lights to simulate the appearance of a light 300 circling or orbiting about a center of the distance display 105 (see FIG. 3) to allow any nearby service technician and/or site operator to determine the status of the EV charger from a position that is remote from the EV charger. Preferably after the communication mode is complete, the EV charger may show on the near display 110 that the EV charger and electric vehicle are ready to charge. The “Ready to Charge” alphanumeric information may be presented with a green background to suggest the EV charger is ready to continue to the next mode of operation (FIG. 6B).

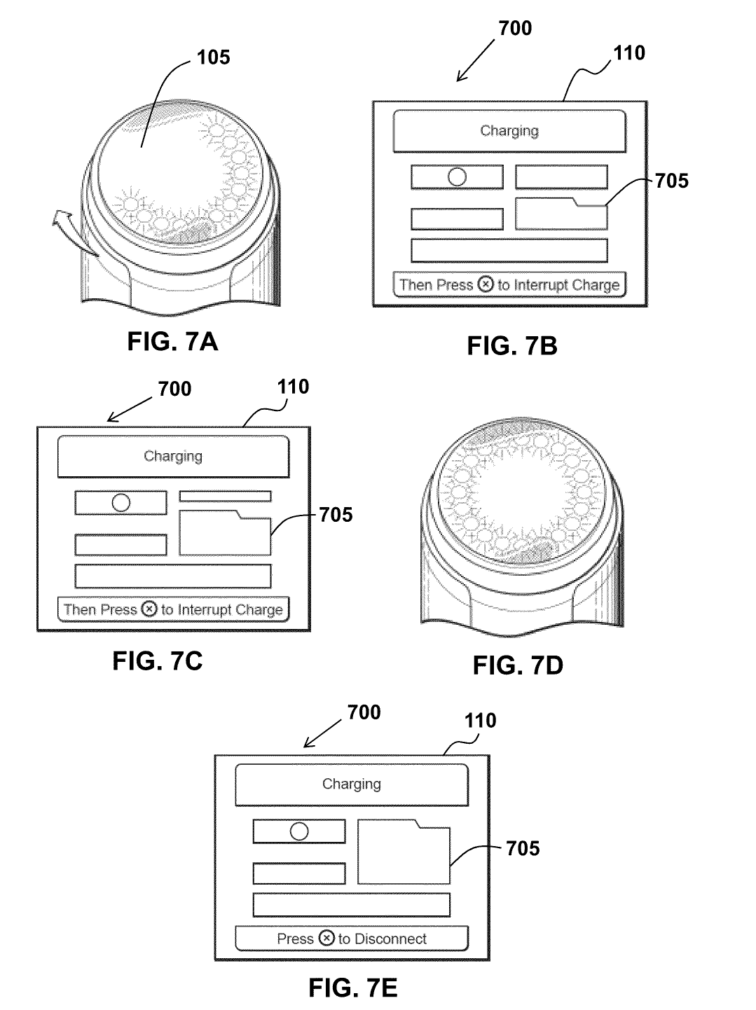

FIGS. 7A, 7B, 7C, 7D, and 7E illustrate one embodiment of information provided by the distance and near displays during charging of an electric vehicle. In one embodiment, the “Ready to Charge” screen on the near display 110 illustrated in FIG. 6B may be switched automatically to a charging screen 700 that displays a scale 705 to indicate the SOC or percent of charge of the charging electric vehicle. While charging, the distance display 105 may show a non-alphanumeric representation of the general SOC of the vehicle. In one embodiment illustrated in FIG. 7A, the non-alphanumeric representation is a number of stationary lights simulated about a perimeter of the distance display, with the number of stationary lights displayed spanning a percentage of the perimeter of the distance display that is in proportion to the SOC of a charging EV. For example, seventeen lights illuminated out of a total of twenty lights spanning the perimeter of the distance display may represent an approximate vehicle SOC of 85%. In alternative embodiment, the portion of the lights that are lit relative to all the lights on the display may be the same or approximately equal to or correspond to the general SOC of the vehicle. In some embodiments, the SOC for a display where all the lights on the distance display are lit may represent either 100% charged, 80% charged, or some other predetermined value of the charge. This SOC meter allows an observer remote from the EV charger to easily and quickly determine the approximate SOC for the electric vehicle currently charging and thus estimate when the current user may complete charging their electric vehicle. As illustrated in FIG. 7A, an SOC is indicated on the distance display of just over half its total, and given that for some electric vehicles (such as the 2012 model years of the Nissan Leaf offered by Nissan Motor Co. Ltd.), which can be direct-current (DC) fast charged (level 3) to 80% capacity in about thirty minutes, an observer that is remote from the EV charger may estimate that the current user of the EV charger will complete their charging in less than about 15 minutes. Note that the white arrow placed on the image of FIG. 7A indicates the direction of further illumination of the vehicle charge indicator as the electric vehicle charges. In FIG. 7C, the scale 705 on the charging screen 700 of the near display 110 is illustrated as having grown in height, indicating further charging of the electric vehicle has been accomplished. In FIGS. 7D and 7E, the distance and near displays, respectively, indicate a “full charge.” A “full charge” is typically indicated on the distance or top display as being set at 80% charged, which corresponds to the termination of Level 3, e.g., fast charging. In some embodiments, the EV charger operates such that when the SOC of the electric vehicle is between 80% to 100% charge, the EV charger charges at a much reduced rate of charging, such as at Level 2 charging, so as to prevent overheating and damage of the batteries in the electric vehicle. In some embodiments, a full perimeter of lights on the top display may correspond to 100% charged, or any other percentage as designated by the user or operator. The full perimeter of lights displayed on the distance display allows a user or potential user to see from a distance the status of the charging of their electric vehicle. As noted, one example of such distance charging status determination may be done while the user is waiting at a coffee shop or restaurant across the street for their electric vehicle to be charged. Upon completion of charging, the EV charger may return to the charger available indication on the distance display, such as the simulation of three lights orbiting within the distance display as illustrated in FIG. 4A. At this point, while the charging is complete, the charger connector may still be connected to the electric vehicle and the charger may still in communication with the electric vehicle.

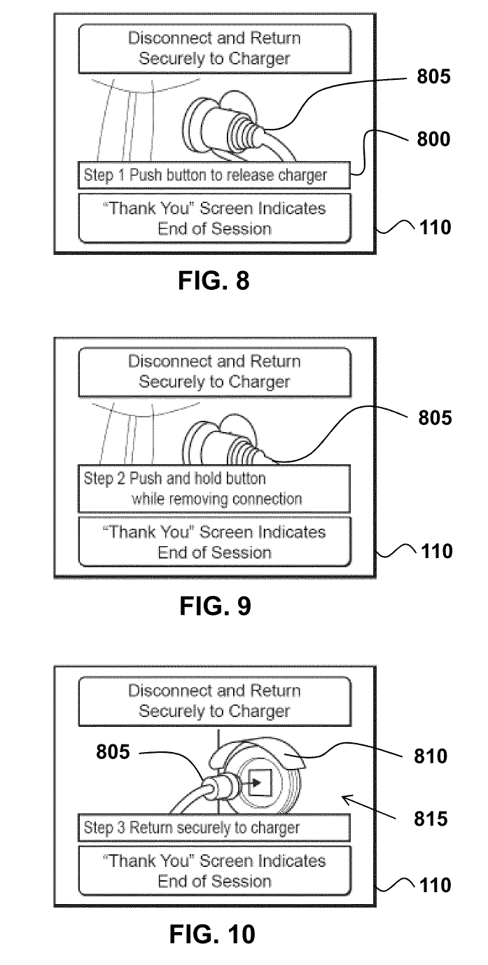

FIGS. 8, 9 and 10 illustrate successive screens that may be displayed on the near display 110 after conclusion of charging of an electric vehicle providing instructions on how to secure the EV charger for future use. In FIG. 8, the user is instructed to push the connector button 800 to release the charging connector 805 from the electric vehicle. In FIG. 9, the user is reminded to continue pushing and holding the button while the charging connector is removed from the electric vehicle. In FIG. 10, the user is explicitly instructed to return the charging connector to a holster 810 of the EV charger 815. After the charging connector is returned to the cradle of the charger, the screen may return to the welcome screen and the charger is ready to be used by the next user.

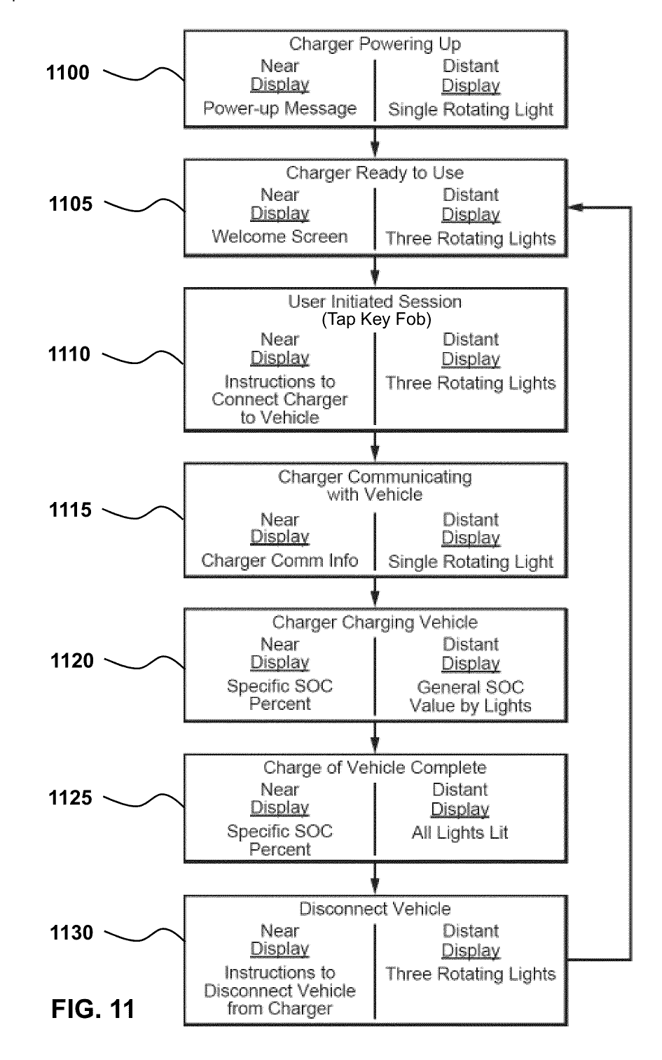

FIG. 11 is a flow diagram of one embodiment of a method for displaying EV charger mode information to actual users, potential users, or service technicians of the EV charger that may positioned at remote or proximal positions from the EV charger. The EV charger enters a powering up mode and the near display may display a power-up message for a user proximal to the EV charger (a “proximal user”) while the distance display provides a single orbiting light indicating the powering up mode to an observer that may be remote from the EV charger (a “remote viewer”) (Block 1100). The EV charger may then enter a ready-to-use mode and the near display may display a “welcome” screen for the proximal user while the distance display provides three orbiting lights to indicate the ready-to-use mode for a remote viewer (Block 1105). If a user initiates a new charging session on the EV charger, such as by tapping their electric vehicle key fob on the near display, the EV charger may enter a charging instructions mode and may be configured to display through the near display instructions for a proximal user to connect the charger connector to an electric vehicle (Block 1110). The distance display may continue to display three orbiting lights to indicate to a remote viewer that the EV charger is not yet charging and so is available for use (Block 1110). The EV charger may then enter a communicating mode to establish communication with the electric vehicle, with the near display providing charger communication information while the distance display indicates the EV charger is not available for use, such as with a single rotating light on the distance display (Block 1115). As the EV charger transitions to charging mode, the near display may display a specific SOC amount or percent and the distant display provide a general SOC to a remote user by way of proportional lighting of the distance display (Block 1120). Once charging of the electric vehicle is complete, the near display may display the specific SOC percentage while the distance display is driven to illuminate all of its light indicators (Block 1125). When the charging is complete, the near display may provide instructions to the proximal user to disconnect the electric vehicle from the charger and a remote user may be provided with information that the EV charger is again available for charging, such as with three orbiting lights on the distance display (Block 1130)

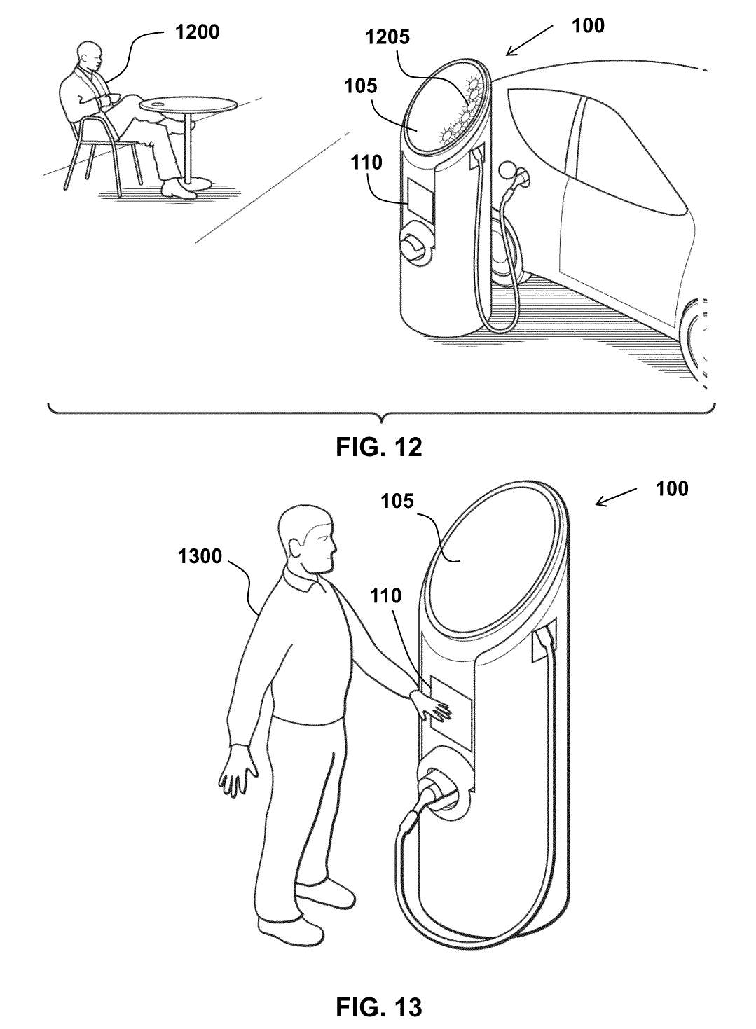

FIGS. 12 and 13 illustrate the relative difference between a proximal user and remote observer of the EV charger. In FIG. 12, a remote observer 1200 of the EV charger 100 is depicted seated at a table at a distance from the near display 110 that would make reading of alphanumeric information presented relatively difficult. For example, the remote observer may be waiting for their vehicle to charge at a nearby coffee shop, restaurant or nearby waiting area within view of the EV charger but not especially close enough to read text on the near display. The distance display 105 is provided on the EV charger 100 to provide preferably non-alphanumeric information in an easily observed format, such as a sequence or number of lights 1205 presented on the distance display 105. In contrast, a proximal user 1300 depicted in FIG. 13 may be standing adjacent the EV charger 100 and thus close enough to read any reading alphanumeric information of usual size presented on the near display 110.

What is claimed is:

1. An electric vehicle (EV) charger system, comprising:
an EV charger, the EV charger having:
a distance display disposed at a top portion of the EV charger, the EV charger configured to display a non-alphanumeric representation of a plurality of modes of the EV charger on the distance display for viewing by an observer remote from the EV charger; and
a near display disposed at a position on the EV charger that is below the distance display, the EV charger configured to display alphanumeric information on the near display for viewing by a user proximal to the EV charger.

2. The EV charger system of claim 1, wherein the distance display comprises a plurality of lights arranged in a circular pattern.

3. The EV charger system of claim 2, wherein the plurality of lights are disposed under a translucent cover.

4. The EV charger system of claim 2, wherein the EV charger is configured to drive the plurality of lights to simulate a light orbiting about a center of the distance display while in an EV charger mode that is selected from the group consisting of: an initial start-up mode, a powering up mode, a shutting down mode, a software update mode, a diagnostic check mode, a communicating mode, and a charging instructions mode.

5. The EV charger system of claim 2, wherein the EV charger is configured to drive the plurality of lights to simulate a plurality of lights orbiting about a center of the distance display.

6. The EV charger system of claim 2, wherein the EV charger is configured to drive the plurality of lights to simulate one or more stationary lights while in charging mode, the number of stationary lights displayed spanning a percentage of the perimeter of the distance display that is in proportion to the state of charge (SOC) of a charging electric vehicle, when an electric vehicle is connected to the EV charger for charging.

7. The EV charger system of claim 6, wherein the EV charger is configured to display a scale on the near display indicating the SOC of the charging EV for viewing by the user.

8. The EV charger system of claim 2, wherein the EV charger further comprises a charging connector for connecting to an electric vehicle.

9. An electric vehicle (EV) charger system, comprising:
a charging connector for connecting to an electric vehicle;
a near display for displaying information to a user of an EV charger, wherein the information relates to at least one of: the operation of the EV charger and a charging status of the vehicle; and
a distance display for displaying information related to at least one of: the operation of the EV charger and the charging status of the vehicle, the distance display viewable by the user at a distance from the EV charger.

10. The EV charger system of claim 9, wherein the distance that the distance display is viewable by the user is greater than the distance that the user can view information on the near display.

11. The EV charger system of claim 9, wherein the near display is a flat panel monitor having a touch screen.

12. The EV charger system of claim 9, wherein the distant display has a circle of lights that can be individually illuminated in patterns.

13. The EV charger system of claim 12, wherein the circle of lights can be illuminated to show a set of lights orbiting about a center of the distant display when the charger is available for use.

14. The EV charger system of claim 12, wherein the circle of lights can be illuminated to show the state of charge (SOC) of the vehicle.

15. A method of displaying a charging status of an electric vehicle (EV) charger system, comprising:
displaying a non-alphanumeric representation of at least one of a plurality of modes of an EV charger on a distance display disposed at a top end of the EV charger; and
displaying alphanumeric information on a near display disposed at a position on the EV charger that is below the distance display.

16. The method of claim 15, wherein displaying the non-alphanumeric representation of the at least one of the plurality of modes of the EV charger comprises displaying a plurality of lights in sequence to simulate a light orbiting about a center of the distance display.

17. The method of claim 15, wherein displaying the non-alphanumeric representation of the at least one of the plurality of modes of the EV charger comprises displaying a plurality of lights in sequence to simulate a plurality of lights orbiting about a center of the distance display.

18. The method of claim 17, wherein displaying alphanumeric information on the near display comprises displaying a user welcome screen.

19. The method of claim 17, further comprising:
tapping a key fob on the near display to start the EV charger for a user to charge an electric vehicle.

20. The method of claim 19, further comprising:
displaying on the near display instructions for use of the EV charger in response to the tapping of the key fob.

21. The method of claim 20, further comprising:
switching the simulation of the plurality of lights orbiting about the center of the distance display to a simulation of a single light orbiting about a center of the distance display.

22. The method of claim 15, wherein displaying the non-alphanumeric representation of the at least one of the plurality of modes of an EV charger comprises displaying a plurality of stationary lights, the plurality of stationary lights spanning a percentage of the perimeter of the distance display that is indicative of the state of charge (SOC) of a charging EV.

23. The method of claim 22, wherein a span of 100% of the perimeter of the distance display attained by the plurality of stationary lights indicates an 80% charge of the electric vehicle in accordance with Level 3 charging.

24. The method of claim 22, wherein a span of 100% of the perimeter of the distance display attained by the plurality of stationary lights indicates an 100% charge of the electric vehicle in accordance with Level 2 charging.

25. The method of claim 22, further comprising:
displaying on the near display a scale indicating the state of charge (SOC) of the charging EV.

26. A method of displaying a charging status of an electric vehicle (EV) charger system, comprising:
displaying on a distant display of an EV charger a single orbiting light to indicate a charger powering up mode for observers remote from the EV charger; and
displaying on a near display of the EV charger a power-up message to indicate the charger powering up mode.

27. The method of claim 26, further comprising:
displaying on the distant display a plurality of orbiting lights to indicate a charger ready-for-use mode for observers remote from the EV charger system; and
displaying on the near display a welcome screen to indicate the charger ready-for-use mode for a user.

28. The method of claim 27, further comprising:
displaying on the distant display a plurality of orbiting lights during a user initiated session for observers remote from the EV charger system; and
displaying on the near display instructions to connect the charger to the electric vehicle.

29. The method of claim 27, further comprising:
displaying on the distant display a single orbiting light during a user initiated session for observers remote from the EV charger system; and
displaying on the near display instructions to connect the charger to the electric vehicle.

30. The method of claim 28, further comprising:
displaying on the distant display a single orbiting light during a communicating mode for observers remote from the EV charger system; and
displaying on the near display charger communication information for the user.

31. The method of claim 30, further comprising:
displaying on the distant display a plurality of lights spanning a portion of a perimeter of the distant display, the ratio of the portion of the perimeter to the complete perimeter indicative of the general state of charge (SOC) of the electric vehicle for observers remote from the EV charger system; and
displaying on the near display a specific SOC percent of the electric vehicle for the user.

32. The method of claim 31, further comprising:
displaying on the distant display a plurality of lights spanning the entire perimeter of the distant display to indicate completion of charging of the electric vehicle for observers remote from the EV charger system; and
displaying in the near display a SOC percent of the electric vehicle for the user that indicates the charge of the vehicle is complete.

33. The method of claim 32, further comprising:
displaying on the distant display a plurality of orbiting lights after charging of the electric vehicle is complete; and
displaying in the near display instructions for detaching a charging connector from the electric vehicle and for returning the charging connector to a cradle of the EV charger.
